(19) United States
(12) Patent Application Publication
(10) Pub. No.: US 2008/0283201 A1
(43) Pub. Date: Nov. 20, 2008

(54) Hinged door having multiple screens

(75) Inventors: Richard L. Beck, Strasburg, OH (US); Ryan M. Straits, Sugarcreek, OH (US)

Correspondence Address: SAND & SEBOLT, AEGIS TOWER, SUITE 1100, 4940 MUNSON STREET, NW, CANTON, OH, 44718-3615, US

(73) Assignee: Precision Entry, Inc., Sugarcreek, OH (US)

(21) Appl. No.: 11/803,764

(22) Filed: May 16, 2007

(51) Int. Cl. E06B 3/38

(52) U.S. Cl. 160/115; 160/245

(57) ABSTRACT

A door assembly includes a door body; a first panel slidably mounted on the door body; a second panel slidably mounted on the door body; a first retractable screen mounted on the door body and connected to the first panel; and a second retractable screen mounted on the door body and connected to the second panel. The panels typically includes window panes and are openable to create a pair of spaced openings through the door which are covered by the retractable screens.

### BACKGROUND OF THE INVENTION

1. Technical Field

The present invention relates generally to hinged doors. More particularly, the invention relates to such a door having a retractable screen. Specifically, the invention relates to such a door having more than one retractable screen.

2. Background Information

It is known in the art to mount a retractable screen on a door so that the screen is deployable as a window on the door is slid to an open position and retracted as the window is slid to a closed position. However, such doors create only a single screened opening when the window is in the open position, which has limitations especially with respect to airflow through the door. Thus, there is a need in the art for a door having multiple retractable screens.

### BRIEF SUMMARY OF THE INVENTION

A door assembly comprising a door body; a first panel slidably mounted on the door body; a second panel slidably mounted on the door body; a first retractable screen mounted on the door body and connected to the first panel; and a second retractable screen mounted on the door body and connected to the second panel.

A door assembly comprising a door body; a first panel slidably mounted on the door body between open and closed positions; a second panel slidably mounted on the door body between open and closed positions; a first retractable screen mounted on the door body and connected to the first panel so that the first screen extends when the first panel moves toward its open position and retracts when the first panel moves toward its closed position; and a second retractable screen mounted on the door body and connected to the second panel so that the second screen extends when the second panel moves toward its open position and retracts when the second panel moves toward its closed position.

A door assembly comprising a door body; a pair of opposed first channels carried by the door body; a pair of opposed second channels carried by the door body; a first panel slidably mounted on the door body within the first channels; a second panel slidably mounted on the door body within the second channels; a first rotatable roller mounted on the door body; a second rotatable roller mounted on the door body; a first retractable screen windingly mounted on the first roller and connected to the first panel; and a second retractable screen windingly mounted on the second roller and connected to the second panel.

### BRIEF DESCRIPTION OF THE SEVERAL VIEWS OF THE DRAWINGS

FIG. 1 is a front elevational view of a first embodiment of the door of the present invention with the windows closed.

FIG. 1A is a sectional view taken on line 1A-1A of FIG. 1.

FIG. 2 is a sectional view taken on line 2-2 of FIG. 1.

FIG. 3 is a front elevational view of the door of the first embodiment with the upper window lowered and the upper screen in the deployed position.

FIG. 4 is a sectional view taken on line 4-4 of FIG. 3.

FIG. 5 is a front elevational view of the door of the first embodiment with the lower window raised and the lower screen in the deployed position.

FIG. 6 is a sectional view taken on line 6-6 of FIG. 5.

FIG. 7 is a front elevational view of the first embodiment with both of the windows open and both of the screens deployed.

FIG. 8 is a front elevational view of a second embodiment of the door of the present invention in which the door includes a kick plate or lower panel.

FIG. 9 is a sectional view taken on line 9-9 of FIG. 8.

FIG. 10 is a front elevational view of the door of the second embodiment with the upper window lowered and the upper screen deployed.

FIG. 11 is a front elevational view of the door of the second embodiment with the lower window raised and the lower screen deployed.

FIG. 12 is a sectional view taken on line 12-12 of FIG. 11.

Similar numbers refer to similar parts throughout the drawings.

### DETAILED DESCRIPTION OF THE INVENTION

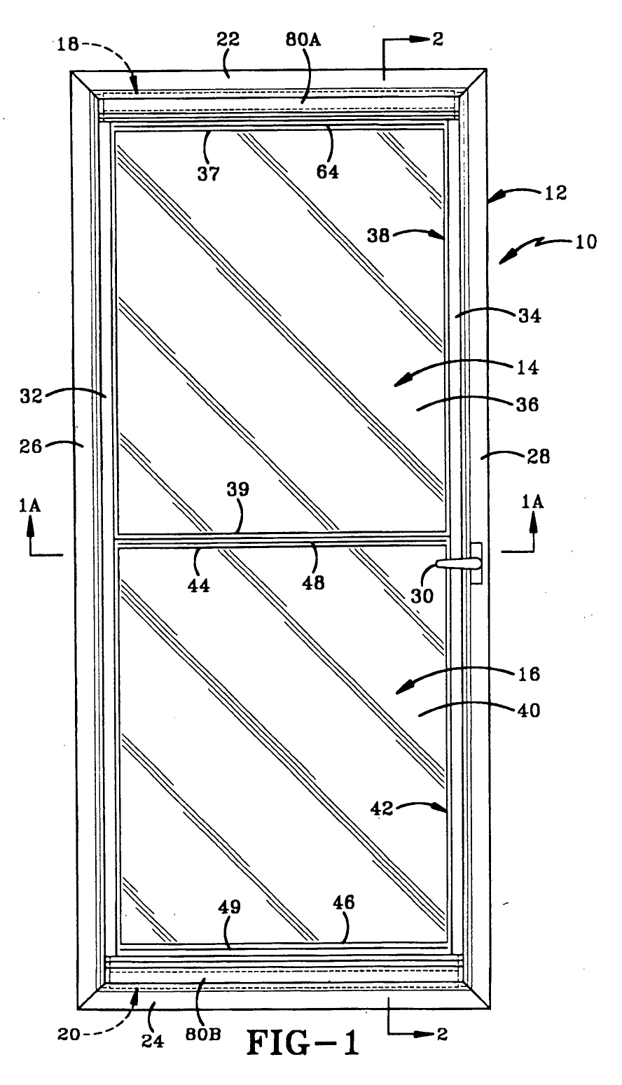

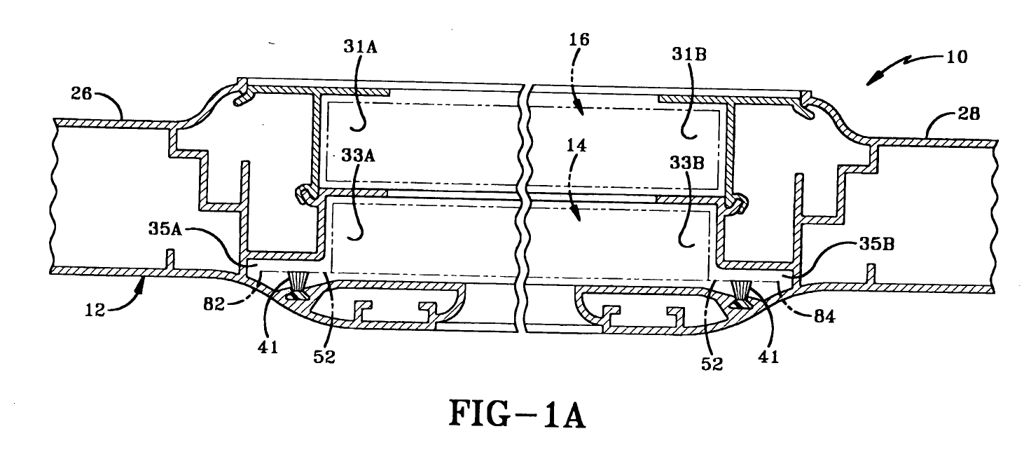

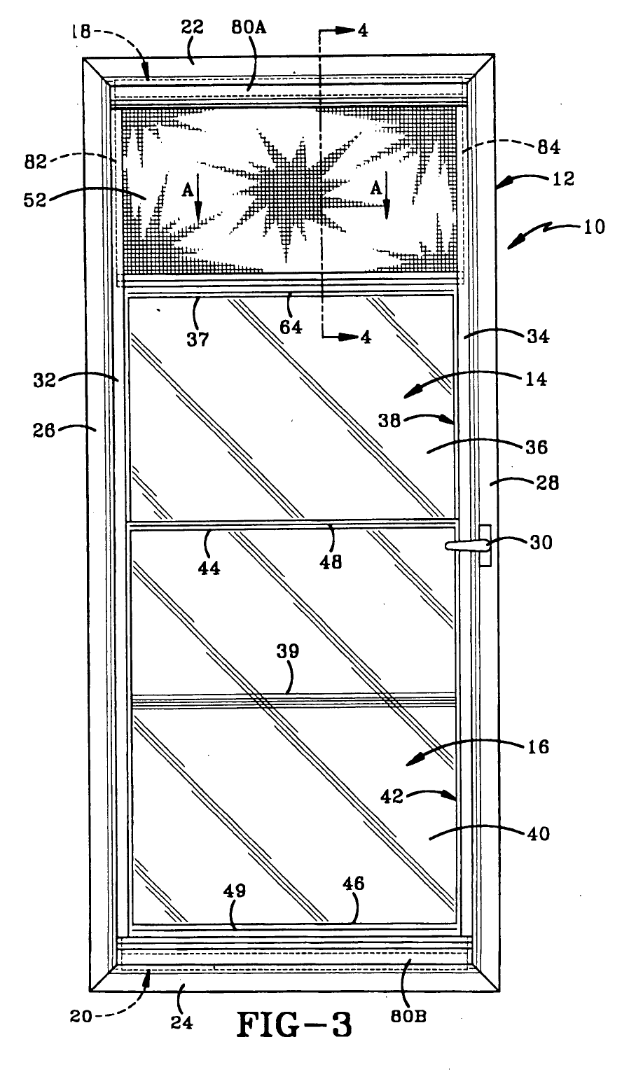

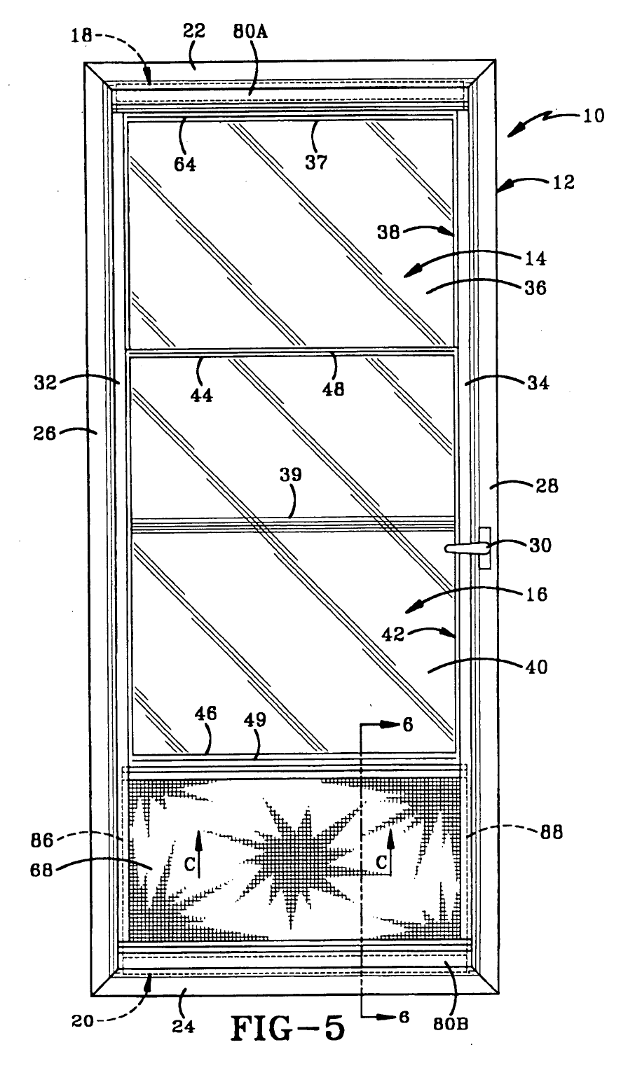

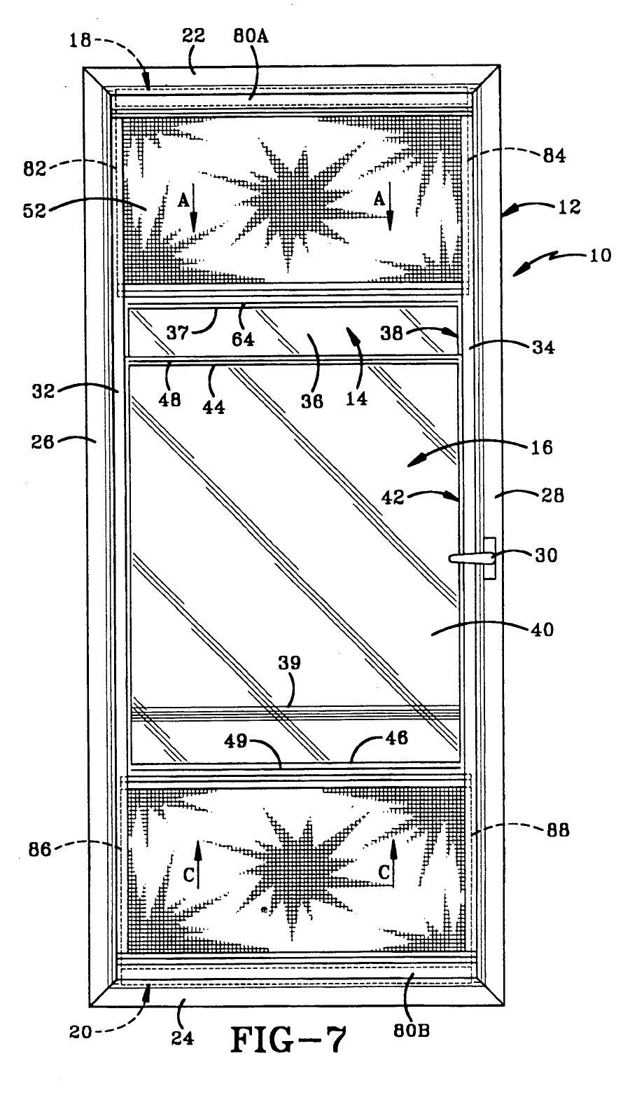

A first embodiment of the door of the present invention is indicated generally at 10 in FIG. 1; and a second embodiment is indicated generally at 100 in FIG. 8. Referring to FIG. 1, door 10 includes a door frame or door body 12 on which are slidably mounted upper and lower panels in the form of windows 14 and 16. Upper and lower retractable screen assemblies 18 and 20 are also mounted on door body 12 and respectively connected to windows 14 and 16. Door body 12 includes a horizontal upper section 22, a horizontal lower section 24, and first and second vertical side sections 26 and 28. A handle 30 is mounted on section 28 and hinges (not shown) are mounted on section 26 to allow door 10 to pivot between open and closed positions. A wiping mechanism 25 (FIGS. 2, 4) is connected to upper section 22 adjacent a lower edge thereof and extends horizontally. Typically, mechanism 25 includes a weather strip with a woven pile projecting outwardly. Likewise, a wiping mechanism 27 (FIGS. 2, 6) having the same configuration is connected to lower section 24 and projects outwardly therefrom.

Referring to FIG. 1A, side section 26 includes a first channel section 32 which extends vertically and includes front and rear vertically extending window-receiving channels 31A and 33A. Likewise, side section 28 includes a second channel section 34 which includes front and rear channels 31B and 33B respectively aligned with channels 31A and 33A. Upper window 14 along its lateral edges is slidably disposed within rear channels 33 of channel sections 32 and 34. Likewise, lower window 16 along its lateral edges is slidably disposed within front channels 31 of channel sections 32 and 34. Rear channels 33 have respective wider sections and narrower sections or screen channels 35A and 35B which extend laterally outwardly beyond the wider sections of channel 33. Rear vertically extending wipers 41 extend inwardly from respective rear walls bounding each screen channel 35. Wipers 41 are typically in the form of a strip of brush-like material or the like. Referring to FIG. 1, upper window 14 includes a window pane 36 and a sash 38 which circumscribes pane 36 and includes upper and lower sections 37 and 39 and spaced side sections extending therebetween. Likewise, lower window 16 includes a window pane 40 with a sash 42 circumscribing pane 40 and including upper and lower sections 44 and 46 and side sections extending therebetween.

Referring to FIG. 2, lower section 39 and upper section 44 in the closed position of windows 14 and 16 overlap and abut one another to substantially prevent air, water, dust and the like from passing through the door. Upper and lower sections 44 and 46 respectively include outwardly projecting handles 48 and 49 to assist in the raising window 16. Upper screen assembly 18 includes a spring-loaded retraction mechanism having a roller 50 on which a screen 52 is windingly mounted. A lower reinforced mounting edge 54 is attached to screen 52 and removably mounted on upper section 37 of sash 38. More particularly, upper section 37 includes a vertically projecting mounting arm 56 to which mounting edge 54 is removably connected by a mounting mechanism 58. Mechanism 58 typically includes a hook and loop fastener or a self-mating reclosable fastener such as sold under the trademark Dual Lock, available from the Minnesota Mining and Manufacturing Company (3M). Other suitable fasteners may be used. Roller 50 and screen 52 are housed within an interior chamber 60 defined by upper section 22 of door body 12. An entrance opening 62 is provided in communication with interior chamber 60 to allow screen 52 to pass therethrough during extension and retraction thereof. Upper section 37 of sash 38 includes a handle 64 to facilitate the lowering and raising of window 14.

With continued reference to FIG. 2, screen assembly 20 includes a spring-loaded retraction mechanism including a rotatable roller 66 on which a screen 68 is windingly mounted to allow extension and retraction thereof. Lower section 24 of door body 12 defines an interior chamber 70 in which roller 66 and screen 68 are housed. An entrance opening 72 to chamber 70 is provided to allow for the extension and retraction of screen 68 therethrough. A reinforced upper mounting edge 74 is attached to screen 68 and is removably connected to a vertically extending rail or wall 76 of lower section 46 by a mounting mechanism 78 having the same characteristics of mounting mechanism 58. Upper and lower sections 22 and 24 of door body 12 respectively include removable covers 80A and 80B which may be removed to allow for the removal and replacement of screen assemblies 18 and 20.

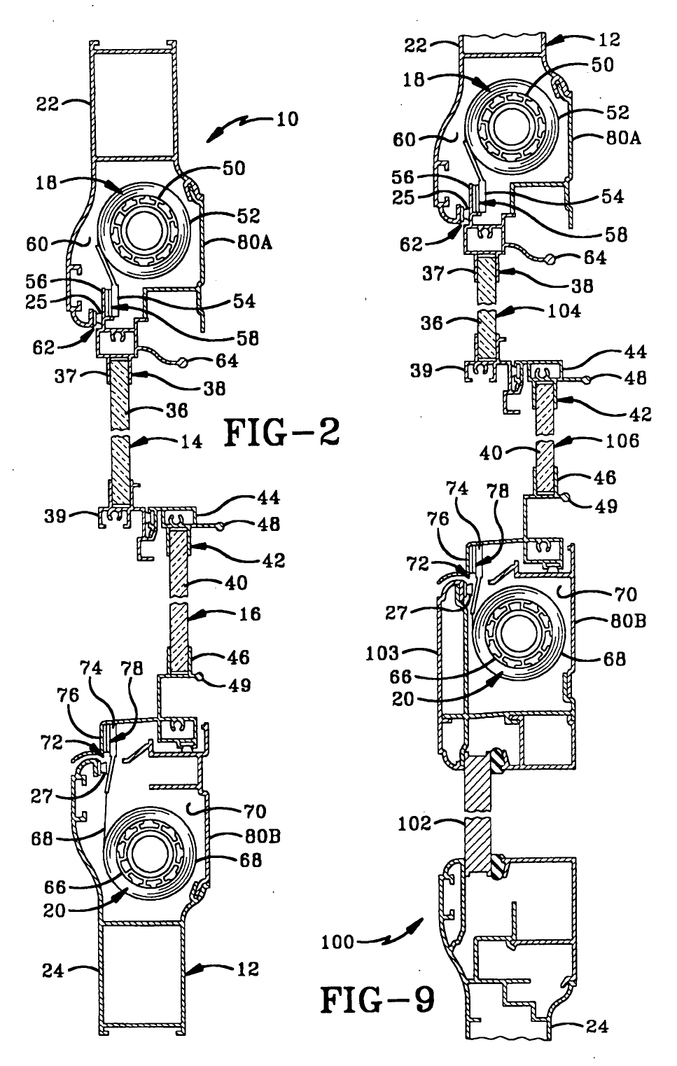

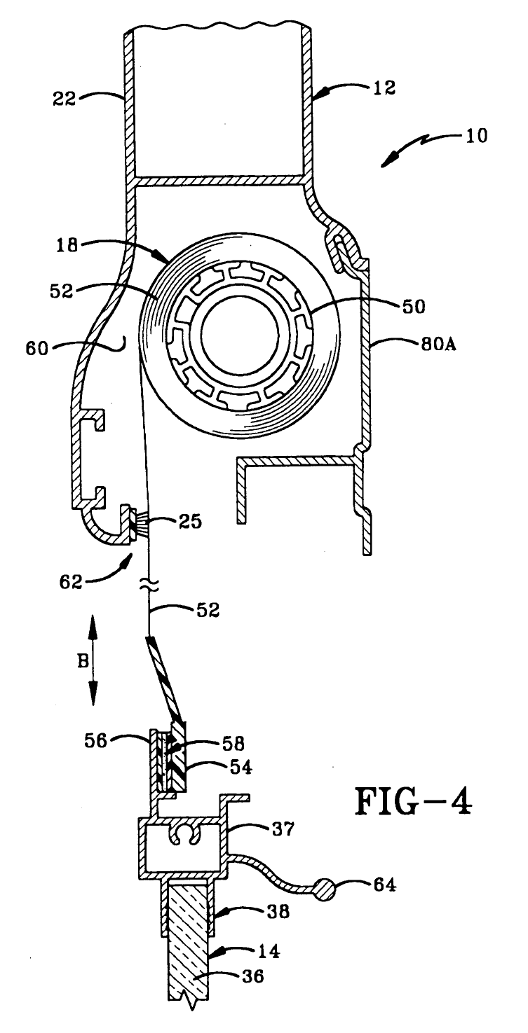

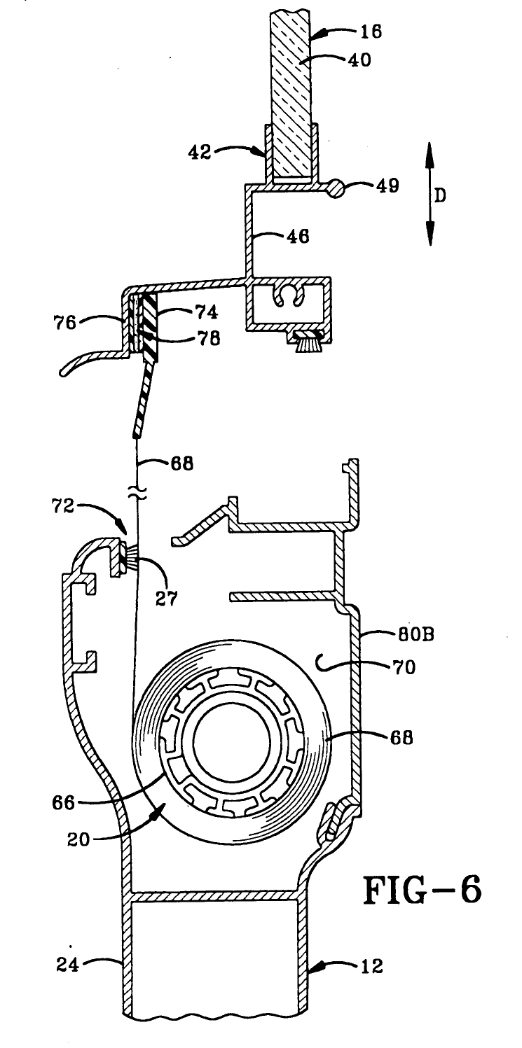

The operation of door 10 is now described with reference to FIGS. 3-7. As shown in FIG. 3, window 14 may be lowered via handle 64 (FIG. 2), thereby unwinding screen 52 against the spring force of the spring-loaded mechanism of assembly 18 so that a portion of screen 52 moves downwardly as indicated at arrows A to cover the opening created by the lowering of window 14. During this extension of screen 52 downwardly, lateral edges 82 and 84 of screen 52 slidably pass through the respective rear window and screen channels 33 and 35 (FIG. 1A) of channel sections 32 and 34. When window 14 is raised, screen 52 is automatically retracted onto roller 50 via the spring-loaded retraction mechanism of assembly 18. The extension and retraction movement of screen 52 is indicated at arrow B in FIG. 4. During this extension and retraction, screen 52 slidably engages wiping mechanism 25, which thus wipes screen 52 to help keep it clean. Mechanism 25 also abuts a portion of upper section 37 when window 14 is raised to provide a weather seal. As shown in FIG. 5, lower window 16 may also be opened by raising and to accordingly pull a portion of screen 68 therewith as indicated at arrows C as screen 68 unwinds from roller 66 (FIG. 2) against the spring force of the spring-loaded retraction mechanism of assembly 20. Screen 68 thus covers the opening created by the raising of window 16. During extension and retraction of screen 68, lateral edges 86 and 88 thereof pass through the forward channels 31 of channel sections 32 and 34. The retraction and extension movement of screen 68 is indicated at arrow D in FIG. 6. During this retraction and extension, screen 68 slidably engages wiping mechanism 27, which wipes screen 68 to help keep it clean in the same manner as wiping mechanism 25. Mechanism 27 also provides a weather seal when window 16 is lowered between lower section 24 of door body 12 and lower section 46 of sash 42 via mounting edge 74. As shown in FIG. 7, each of windows 14 and 16 may thus be opened to create respective upper and lower openings through door 12 which are covered respectively by screens 52 and 68. Thus, door 10 is configured to provide for a plurality of openings which are covered by respective screens to allow for better control of air flow through door 10, which may be enhanced by fans or the like, thus providing for better temperature control.

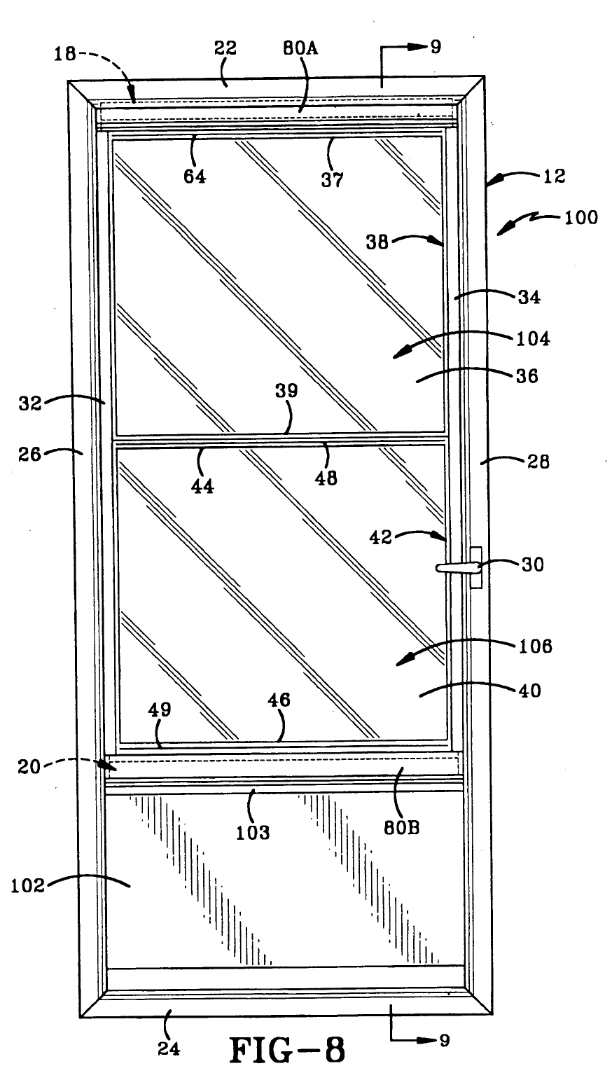

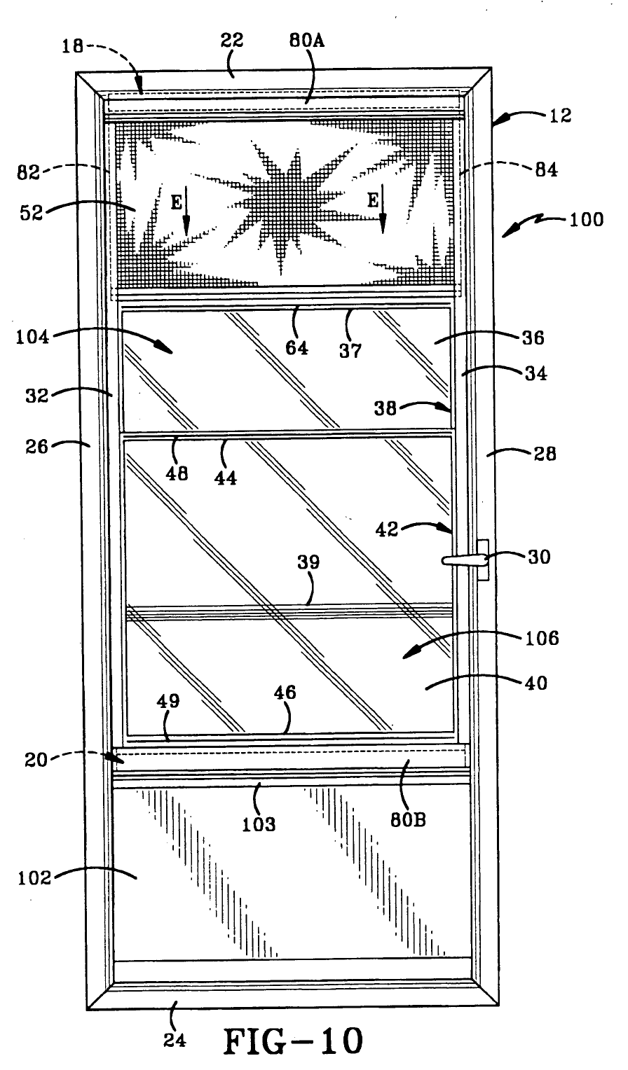

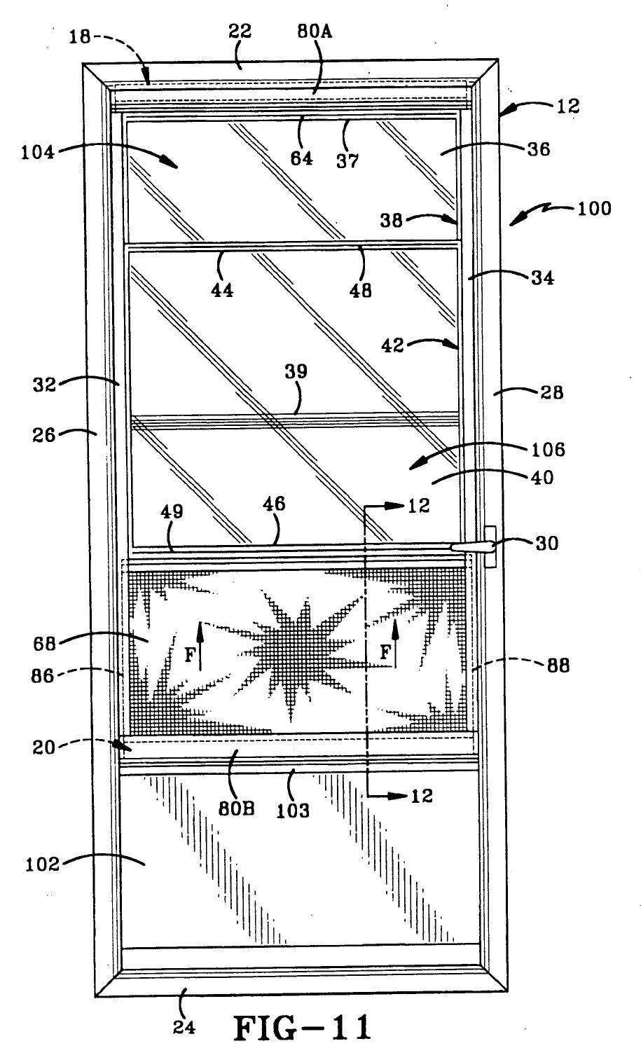

Door 100 is now described with reference to FIGS. 8-12. Door 100 is similar to door 10 except that door 100 includes a kick plate or a preferably rigid lower panel 102 and an intermediate section 103 seated atop lower panel 102 so that the windows of door 100 may be smaller than the windows of door 10 and the lower window is positioned higher than that of door 10. Thus, door 100 includes a door body on which are slidably mounted upper and lower windows 104 and 106 having the same configuration as windows 14 and 16 except for being smaller in size. Thus, window 104 may be lowered as shown in FIG. 10 so that screen 52 is extended as shown at arrows E. Likewise, lower window 106 may be raised as shown in FIG. 11 so that lower screen 68 is extended upwardly as indicated at arrows F. It is noted that a panel similar to panel 102 may be positioned at any height on the door, not just at the bottom.

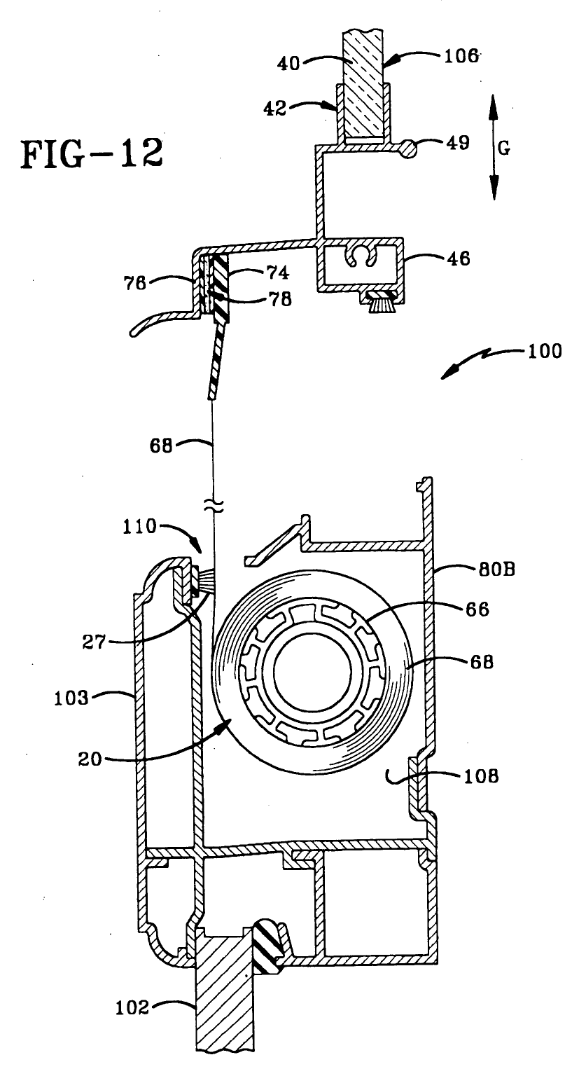

Referring to FIG. 12, the retraction and extension movement of screen 68 are indicated at arrow G. In addition, FIG. 12 shows intermediate section 103 of the door body mounted atop lower panel 102 and defining an interior chamber 108 having an entrance opening 1 10 through which screen 66 passes during retraction and extension. Windows 104 and 106 of door 100 may be simultaneously opened so that screens 52 and 68 cover respective openings through door 100.

It will be appreciated by one skilled in the art that various changes may be made within the scope of the present invention. While doors 10 and 100 show a pair of windows and a pair retractable screen assemblies, it is within the scope of the present invention to form doors in which there are additional windows and respective retractable screen assemblies. In addition, the windows may be configured to slide laterally or otherwise with respective attached screens moving accordingly.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A door assembly comprising:
a door body;
a first panel slidably mounted on the door body;
a second panel slidably mounted on the door body;
a first retractable screen mounted on the door body and connected to the first panel; and
a second retractable screen mounted on the door body and connected to the second panel.

2. The assembly of claim 1 wherein the first and second panels slide in opposite directions to respectively open.

3. The assembly of claim 2 wherein the first panel slides downwardly to open; and the second panel slides upwardly to open.

4. The assembly of claim 3 wherein the first panel is an upper panel and the second panel is a lower panel.

5. The assembly of claim 4 wherein the door body comprises a lower panel and an intermediate section disposed atop the lower panel; and the second screen is mounted on the intermediate section.

6. The assembly of claim 5 further comprising a roller which is rotatably mounted on the intermediate section and on which the second screen is windingly mounted.

7. The assembly of claim 1 wherein the first panel is capable of being open when the second panel is open.

8. The assembly of claim 7 wherein when the first panel is open the door body and first panel together define a first opening covered by the first screen; and when the second panel is open the door body and second panel together define a second opening covered by the second screen.

9. The assembly of claim 1 wherein the first screen is removably connected to the first panel.

10. The assembly of claim 9 wherein the second screen is removably connected to the second panel.

11. The assembly of claim 1 wherein the first panel comprises a first window pane.

12. The assembly of claim 11 wherein the second panel comprises a second window pane.

13. The assembly of claim 1 wherein the door body comprises a pair of opposed first channels in which the first panel is slidably disposed and a pair of opposed second channels in which the second panel is slidably disposed; the first screen is slidably received in the first channels; and the second screen is slidably received in the second channels.

14. The assembly of claim 1 wherein the door body comprises a pair of opposed first channels in which the first panel is slidably disposed and a pair of opposed second channels in which the second panel is slidably disposed; the first screen has opposed edges which respectively pass through the first channels during extension and retraction thereof; and the second screen has opposed edges which respectively pass through the second channels during extension and retraction thereof.

15. The assembly of claim 1 further comprising a retraction mechanism for automatically retracting the first screen when the first panel moves toward a closed position; and a second retraction mechanism for automatically retracting the second screen when the second panel moves toward a closed position.

16. The assembly of claim 15 wherein the first and second retraction mechanisms are spring loaded.

17. The assembly of claim 1 wherein the screens are removably mounted on the door body.

18. The assembly of claim 1 further comprising a first rotatable roller on which the first screen is windingly mounted; and a second rotatable roller on which the second screen is windingly mounted.

19. A door assembly comprising:
a door body;
a first panel slidably mounted on the door body between open and closed positions;
a second panel slidably mounted on the door body between open and closed positions;
a first retractable screen mounted on the door body and connected to the first panel so that the first screen extends when the first panel moves toward its open position and retracts when the first panel moves toward its closed position; and
a second retractable screen mounted on the door body and connected to the second panel so that the second screen extends when the second panel moves toward its open position and retracts when the second panel moves toward its closed position.

20. A door assembly comprising:
a door body;
a pair of opposed first channels carried by the door body;
a pair of opposed second channels carried by the door body;
a first panel slidably mounted on the door body within the first channels;
a second panel slidably mounted on the door body within the second channels;
a first rotatable roller mounted on the door body;
a second rotatable roller mounted on the door body;
a first retractable screen windingly mounted on the first roller and connected to the first panel; and a second retractable screen windingly mounted on the second roller and connected to the second panel.
